(19) United States
(12) Patent Application Publication
(10) Pub. No.: US 2026/0268085 A1
(43) Pub. Date: Sep. 10, 2026

(54) MACHINE LEARNING-BASED CORRELATION OF TEXTUAL RESPONSES AND CONTEXT-SPECIFIC SURVEY TOPICS

(71) Applicant: Qualtrics, LLC, Provo, UT (US)

(72) Inventors: Daniel Perry, Seattle, WA (US); Sakib Haque, Falls Church, VA (US); Mark Arehart, Reston, VA (US); Evan Paul Child, Provo, UT (US); Recep Colak, Seattle, WA (US)

(21) Appl. No.: 19/075,127

(22) Filed: Mar. 10, 2025

(51) Int. Cl. G06F 40/30

(52) U.S. Cl. CPC G06F 40/30

(57) ABSTRACT

This disclosure relates to methods, non-transitory computer readable media, and systems apply machine-learning techniques and computational analysis to correlate verbatim-derived topics with context-driven topics. For instance, the disclosed systems can provide a dataset of verbatim-derived topics determined from one or more verbatims by a topic extraction model and one or more context-driven topics identified independent of the one or more verbatims of the dataset of verbatim-derived topics to a topic disambiguation model. Using the topic disambiguation model, the disclosed systems can generate a mapping of verbatim-derived topics from the dataset of verbatim-derived topics to the one or more context-driven topics. In some cases, the disclosed systems also correlate individual verbatims to input context-driven topics based on a mapping generated by the topic disambiguation model.

### BACKGROUND

Recent years have seen significant improvements in computer hardware and software platforms utilizing natural language processing to evaluate textual content. For example, the widespread use of computing devices and the expanding capabilities of computer systems have resulted in a continuous need to evaluate digital content across various applications and formats. Consequently, due to the vast amount of digital content available, different content analysis systems have been developed to analyze and organize the digital content. Despite the advancements of existing content analysis systems, current systems frequently exhibit technological limitations that give rise to several shortcomings, especially when it comes to offering an efficient and affordable analysis function for extracting meaningful topics from unstructured text while maintaining a correlation between extracted topics, targeted interests, and the unstructured text.

For example, existing content analysis systems often require manually curated queries to extract relevant topics from unstructured textual data. While such systems are capable of identifying targeted topics within provided texts, customized and/or targeted topic extraction is often costly to implement and limited in scope and application. Furthermore, such reliance on customized queries to extract specific topics of interest can be susceptible to low recall within searched texts due to high precision matching leading to false negatives and overlooked topics of relevance. To compensate, some existing systems require exorbitant lists of topics for extraction, resulting in further computational inefficiencies as resulting data requires significant supplementary analysis. Thus, these conventional systems often implement inflexible, inefficient, and expensive processes for analysis of digital content.

### BRIEF SUMMARY

Embodiments of the present disclosure provide benefits and/or solve one or more of the foregoing or other problems in the art with systems, non-transitory computer-readable media, and methods that implement multiple natural language processing pipelines to intelligently identify meaningful and contextually relevant topics from textual content. To illustrate, the disclosed systems utilize a topic disambiguation model to determine correlations between topics identified or selected for a particular context (e.g., customer, industry, or other target schema) and topics extracted directly from provided textual data (e.g., verbatims). In some embodiments, the disclosed systems utilize machine learning-based language models to determine or select context-driven topics, to extract verbatim-derived topics, and/or to generate a mapping of extracted verbatim-derived topics to one or more context-driven topics. Further, in some embodiments, the disclosed systems generate additional contextual information with the aforementioned mapping, including correlations between specific verbatims and extracted topics, keywords, summaries, comments, examples, description, sentiments, and statistical reports.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates a topic optimization system generating a mapping between verbatim-derived topics and context-driven topics in accordance with one or more embodiments.

FIG. 2 illustrates the topic optimization system using a topic disambiguation model to generate a topic-to-topic mapping in accordance with one or more embodiments.

FIG. 3 illustrates the topic optimization system using a context-drivel topic model to generate context-driven topics in accordance with one or more embodiments.

FIG. 4A illustrates the topic optimization system using a topic extraction model to generate a dataset of verbatim-derived topics in accordance with one or more embodiments.

FIG. 4B illustrates the topic optimization system generating verbatim correlations and/or associated explanations and results in accordance with one or more embodiments.

FIG. 5 illustrates the topic optimization system training a topic disambiguation model to recognize connections between low-level topics (e.g., verbatim-derived topics) and high-level topics (e.g., context-driven topics) in accordance with one or more embodiments.

FIG. 6A illustrates the topic optimization system utilizing a computing device to display customer topics (e.g., context-driven topics) within a graphical user interface in accordance with one or more embodiments.

FIG. 6B illustrates the topic optimization system utilizing a computing device to display extracted topics (e.g., verbatim-derived topics) in association with customer topics (e.g., context-driven topics) as a topic hierarchy within a graphical user interface in accordance with one or more embodiments.

FIG. 6C illustrates the topic optimization system utilizing a computing device to display a heatmap representing correlations between verbatims and topics of a topic hierarchy within a graphical user interface in accordance in accordance with one or more embodiments.

FIG. 6D illustrates the topic optimization system utilizing a computing device to display an explanatory report for correlations between a verbatim and a sub-topic (e.g., a verbatim-derived topic) of a customer topic (e.g., a context-driven topic) in accordance with one or more embodiments.

FIG. 7 illustrates a flowchart of a series of acts for generating a mapping of verbatim-derived topics to context-driven topics in accordance with one or more embodiments.

FIG. 8 illustrates a block diagram of an environment in which the topic optimization system can operate in accordance with one or more embodiments.

FIG. 9 illustrates a block diagram of an exemplary computing device in accordance with one or more embodiments.

FIG. 10 illustrates a network environment of an experience management system in accordance with one or more embodiments.

### DETAILED DESCRIPTION

This disclosure describes embodiments of a topic optimization system that utilizes multiple language processing pipelines to intelligently identify meaningful and contextually relevant topics from textual content with increased accuracy, efficiency, and affordability relative to existing content analysis systems. To illustrate, in one or more embodiments, the topic optimization system utilizes a topic disambiguation model to generate a mapping between high-level topics generated or otherwise identified for a particular context or interest and low-level topics derived from one or more input verbatims (e.g., unstructured natural language text). In some embodiments, for example, the topic optimization system utilizes machine learning-based language models to determine context-driven topics (e.g., high-level topics) for a particular customer, industry, or background, to extract verbatim-derived topics (low-level topics) from textual data (e.g., provided verbatim(s)), and/or to generate the aforementioned mapping of the verbatim-derived topics to the context-driven topics.

To illustrate, in some embodiments, the topic optimization system extracts. verbatim-derived topics by determining underlying themes for provided verbatims—without influence from the aforementioned context-driven topics (e.g., independent of context-specific topics. Having extracted (or otherwise received) verbatim-derived topics for the provided verbatims, the topic optimization system utilizes a topic disambiguation model to generate the mapping of the verbatim-derived topics to one or more context-driven topics by determining correlations between the two independent sets of topics. Also, in one or more embodiments, the topic optimization system further correlates the verbatim-derived topics with corresponding verbatims, such that individual verbatims are directly can be associated with topics of the one or more context-driven topics. Additionally, in some embodiments, the topic optimization system provides data extraction results, such as topic/verbatim correlations and analytics of textual data within a graphical user interface.

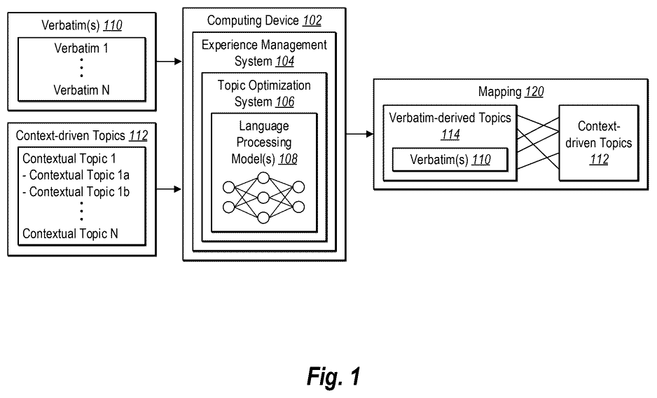

As mentioned, in one or more embodiments, the topic optimization system generates a mapping between high-level topics generated or otherwise identified for a particular context or interest and low-level topics derived from one or more input verbatims (e.g., unstructured natural language text). For example, FIG. 1 shows a topic optimization system 106 generating a mapping 120 between context-driven topics and verbatim-derived topics in accordance with one or more embodiments.

In particular, FIG. 1 illustrates the topic optimization system 106 operating on a computing device 102. Further, FIG. 1 illustrates the topic optimization system 106 operating as part of an experience management system 104. For instance, in some cases, the topic optimization system 106 operates as a sub-system of the experience management system 104 hosted on the computing device 102. Though FIG. 1. illustrates the topic optimization system 106 operating in the context of experience management (e.g., electronic surveys and related features), it should be understood that the topic optimization system 106 can operate in various contexts, in various implementations, and in various environments (e.g., as part of other systems or as its own system). For example, in certain cases, the topic optimization system 106 operates as part of an experience management system 104 that receives feedback from users' digital journeys (e.g., touchpoints leading to conversion or abandonment) and provides experiences (e.g., personalized content) based on that feedback. Thus, the topic optimization system 106 can generate informational responses in contexts in which responses would otherwise be obtained from respondents actively or passively.

Moreover, as indicated above, the topic optimization system 106 can apply multiple models to perform the various content analysis tasked discussed herein. In some cases, the topic optimization system 106 includes or refers to a machine learning model trained to perform computer tasks to generate and/or correlate textual content (e.g., verbatims, topics, keywords, summaries, examples, descriptions, sentiments, context features and context data). A machine learning model includes a computer algorithm or a collection of computer algorithms that can be trained and/or tuned based on inputs to approximate unknown functions. A machine learning model includes a neural network (e.g., a deep neural network) that analyzes a language input to generate a predicted output. For example, a machine learning model includes a neural network that generates topics and associated keywords, summaries, examples, descriptions, and/or sentiments based on an input query and a provided natural language input. In some cases, the machine learning models utilize a transformer architecture, which includes mechanisms such as self-attention, to capture contextual relationships in the data.

To illustrate, a machine learning model can include a computer algorithm with branches, weights, or parameters that change based on training data to improve for a particular task. Thus, a machine learning model can utilize one or more learning techniques (e.g., supervised or unsupervised learning) to improve in accuracy and/or effectiveness. Example machine learning models include various types of decision trees (e.g., gradient boost models), support vector machines, Bayesian networks, random forest models, or neural networks (e.g., deep neural networks, generative adversarial neural networks, convolutional neural networks, recurrent neural networks, or diffusion neural networks). Similarly, as used herein, a neural network refers to a machine learning model of interconnected nodes (or neurons) organized into layers. A neural network can include parameters or weights between neurons that are adjusted during training to minimize the error (or measure of loss) in generating predictions.

As illustrated, for example, the topic optimization system 106 includes or refers to one or more language processing models 108 for performing the content analysis tasked discussed herein. As used herein, the term “language processing model” refers to a computational framework or algorithm configured to understand, interpret, analyze, and/or generate human language. For example, a language processing models can include various types of natural language processing (NLP) models or the like, such as but not limited to a large language model, a cross encoder, a semantic similarity model, an encoder/decoder model, a retriever model, and so forth. While FIG. 1 shows the topic optimization system 106 implementing neural network-based language processing models specifically, in some embodiments the topic optimization system 106 implements or refers to other types of natural language processing models, such as models optimized for text classification, sequence labeling, topic modeling, dependency parsing, word embedding, text similarity matching, machine translation, and so forth.

Along these lines, the models used herein can be trained and/or fine-tuned based on a diverse text corpora to perform natural language processing tasks, such as generating topics, keywords, summaries, examples, descriptions, and sentiments. For example, the machine learning models, consist of layers of interconnected artificial neurons organized in encoder and decoder blocks, which learn complex language patterns to generate textual content. In some cases, the machine learning models include models such as Vicuna, GPT (Generative Pre-trained Transformer), BERT (Bidirectional Encoder Representations from Transformers), T5 (Text-To-Text Transfer Transformer), LLAMA, or similar architectures that utilize self-attention mechanisms in natural language understanding and generation.

As shown in FIG. 1, the topic optimization system 106 receives one or more verbatims 110. As used herein, the term “verbatim” refers to unstructured textual content such as natural language user input. In some embodiments, for example, the verbatims 110 include unstructured textual content sourced from applications, emails, survey responses, conversations, reviews, and/or social posts. In some cases, the verbatims 110 maintain fidelity with the source application through a precise reproduction of the textual content including punctuation, wording, errors, and peculiarities. In some cases, the verbatims 110 include reproductions of the textual content that includes a close approximation of the textual content from the source allowing for minor inaccuracies or adjustments. As an example, the topic optimization system 106 utilizes the verbatims 110 corresponding to user comments (including the words, tone, punctuation) associated with a product, service, or experience to generate topics based on the original textual content without undue alteration or interpretation.

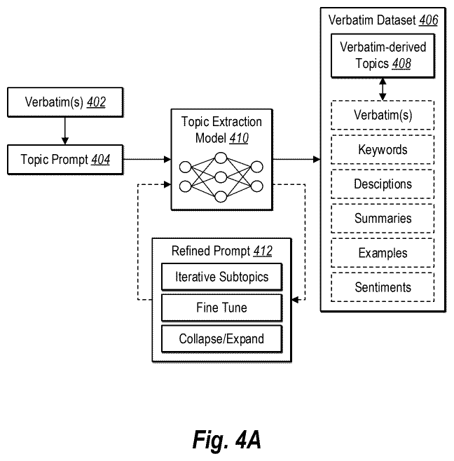

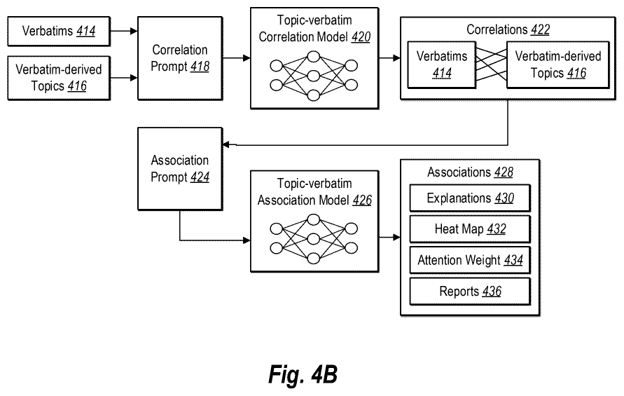

As also shown in FIG. 1, the topic optimization system 106 determines, identifies, or otherwise receives verbatim-derived topics 114 extracted from the one or more verbatims 110. In some embodiments, for example, the topic optimization system 106 utilizes the language processing model(s) 108 to extract topics conveying underlying themes and keywords associated with the verbatim(s) 110. In some cases, the topic optimization system 106 extracts a topic dataset comprising the verbatim-derived topics 114 and keywords or other information associated therewith. In some cases, the topic dataset includes topics associated with the verbatim(s) 110 but does not pinpoint specific instances of the verbatim(s) 110 (e.g., Verbatim 1, Verbatim 2) that directly relate to specific topics of the verbatim-derived topics 114. In such cases, the topic optimization system 106 utilizes generalized patterns and themes within the verbatims 110 to determine the topics. Alternatively, in some embodiments, the topic optimization system 106 includes direct correlations between the verbatim-derived topics 114 and individual verbatims of the verbatim(s) 110 within the resulting topic dataset (e.g., as described below in relation to FIG. 4B).

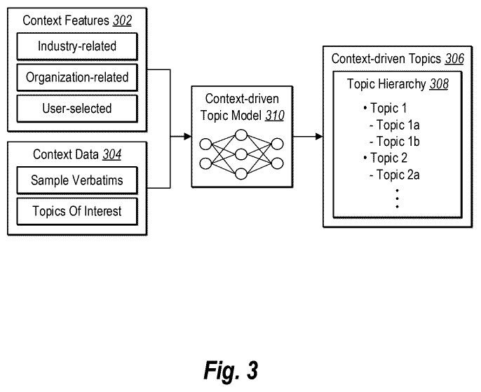

As further shown in FIG. 1, the topic optimization system 106 determines, identifies, or otherwise receives context-driven topics 112 identified independent of the one or more verbatims 110 or the verbatim-derived topics 114. In some cases, the context-driven topics 112 include a hierarchy of nested topics (e.g., categories and sub-categories of interest). As mentioned, the context-driven topics 112 comprise topics identified or selected for a particular context (e.g., customer, industry, or other target schema). In some embodiments, for instance, a user (e.g., a customer) selects various topics of interest as the context-driven topics 112. Alternatively or additionally, the topic optimization system 106 can utilize the language processing model(s) 108 to determine the context-driven topics 112 based on specific contextual information (e.g., as described below in relation to FIG. 3).

As illustrated, the topic optimization system 106 generates the mapping 120 between the verbatim-derived topics 114 (e.g., low-level topics) and the context-driven topics 112 (e.g., high-level topics). In some cases, the verbatim-derived topics 114 may include relatively high-level topics, and the context-driven topics 112 may include relatively low-level topics. In other words, the topic optimization system 106 can identify one or more verbatim-derived topics that fit within a hierarchy of topics at a higher level than one or more of the context-driven topics 112. Similarly, the topic optimization system 106 can identify one or more context-driven topics that fit within a hierarchy of topics at a lower level than one or more of the verbatim-derived topics 114. Moreover, in some cases, the topic optimization system 106 can identify one or more verbatim-derived topics 114 that do not correlate with any of the context-driven topics 112.

Furthermore, in some embodiments, the mapping 120 includes an association of individual verbatims with the verbatim-derived topics 114, such that the mapping 120 also provides a mapping of the verbatim(s) 110 to the context-driven topics 112. Similarly, the mapping can include additional information linked to the context-driven topics 112 by virtue of the correlation between the verbatim-derived topics 114 and the context-driven topics 112, such as keywords, descriptions, summaries, examples, and topic sentiments derived from the verbatim(s) 110.

As suggested above, the topic optimization system 106 provides several advantages over existing content analysis systems. For instance, the topic optimization system 106 enhances accuracy over existing content analysis systems by identifying topics expressed within provided verbatims (e.g., verbatim-derived topics) without narrow targeting of specific topics of interest (e.g., context-driven topics). In particular, by extracting verbatim-derived topics independent of context, the topic optimization system 106 exhibits improved recall of expressed topics within input textual data while providing relevant and traceable context-driven topics correlated with the extracted verbatim-derived topics. Furthermore, in certain cases, by utilizing separate pipelines for determining verbatim-derived topics and context-driven topics, the topic optimization system 106 provides an increased breadth of results relative to existing content analysis system. In some cases, for example, the topic optimization system 106 identifies and correlates verbatim-derived topics not anticipated by a user for inclusion within context-driven topics.

Moreover, the topic optimization system 106 can provide improvements to efficiency and flexibility over existing content analysis systems. In certain embodiments, for instance, instead of requiring custom, manually curated queries for targeted extraction of topics from provided verbatims, the topic optimization system 106 efficiently extracts topics from verbatims independent of context and/or user-specific interests. Indeed, by separately extracting verbatim-derived topics and determining context-driven topics then generating a mapping between the verbatim-derived topics and the context-driven topics, the topic optimization system 106 more efficiently generates relevant, context-focused results compared to existing systems. Furthermore, this separation of analysis pipelines enables the flexibility of separate updates to the respective models and/or inputs without requiring the other respective model to be processed anew (e.g., context-driven topics can be updated then correlated with verbatim-derived topics without repeating their extraction from provided verbatims.

Additionally, in some embodiments, the topic optimization system 106 uses batch processing techniques to analyze large volumes of verbatims efficiently, reducing the computational load on the system. Moreover, by expanding or contracting topics to adapt to the specific analytical needs of the system, the topic optimization system 106 further reduces needless calculations and further optimizes processing time. Indeed, based on these and other efficiencies, the topic optimization system 106 can process large datasets more quickly and efficiently, requiring less system bandwidth and/or memory.

Moreover, the topic optimization system 106 solves technical problems that specifically arise within a computer environment based on the function of machine learning models. Indeed, while large language models and other modes can perform classifications or be used to extract topics from verbatims, the models themselves are technically limited and fail to associate extracted topics back to a specific relevant verbatim. The topic optimization system 106 solves these specific technical problems that arise within the technical area of machine learning by using technics that significantly reduce the number of tokens needed to be provided to additionally trained models to eventually connect a specific verbatim to one or more of the extracted topics. Accordingly, the topic optimization system specifically overcomes a technical problem that arose due to the nature of topic extraction using large language models.

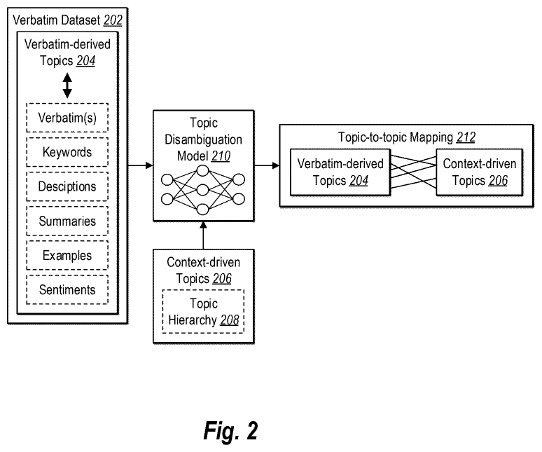

As mentioned, in some embodiments, the topic optimization system 106 determines correlations between high-level topics (e.g., context-driven topics) generated or otherwise identified for a particular context or interest and low-level topics (e.g., verbatim-derived topics) derived from one or more input verbatims. For example, FIG. 2 illustrates an overview of the topic optimization system 106 generating a topic-to-topic mapping 212 of verbatim-derived topics 204 to context-driven topics 206.

As shown in FIG. 2, the topic optimization system 106 determines, receives, or otherwise identifies a verbatim dataset 202 comprising the verbatim-derived topics 204 (e.g., determined from one or more verbatims by a topic extraction model). As illustrated, in some embodiments, the verbatim dataset 202 further includes keywords, descriptions, summaries, examples, sentiments associated with the verbatim-derived topics 204 and, in some cases, individual verbatim(s) associated with the verbatim-derived topics 204 (e.g., one or more verbatims from which the verbatim-derived topics are extracted, as further described below in relation to FIGS. 4A-4B). Further, the topic optimization system 106 determines, receives, or otherwise identifies the context-driven topics 206 independent of the verbatim dataset 202 (e.g., as described below in relation to FIG. 3).

As also shown in FIG. 2, the topic optimization system 106 provides the verbatim dataset 202, including the verbatim-derived topics 204, and the context-driven topics 206 to a topic disambiguation model 210. In some embodiments, for example, the topic optimization system 106 prompts the topic disambiguation model 210 with a custom prompt to cause the topic disambiguation model 210 to determine the mapping between the provided verbatim-derived topics 204 and the provided context-driven topics 206. Based on the custom prompt and the provided topics, the topic disambiguation model 210 determines the topic-to-topic mapping 212. In some cases, the topic-to-topic mapping 212 includes a mapping of the verbatim-derived topics 204 to individual topics within a topic hierarchy 208 of the context-driven topics 206.

In some cases, the topic disambiguation model 210 includes or refers to a machine learning model as described above. In some cases, the topic disambiguation model 210 includes a zero-shot semantic similarity model designed to categorize text data into predefined categories without requiring any prior training on labeled examples of those categories. For example, instead of learning from examples, the zero-shot semantic similarity model leverages an understanding of language and context to make predictions (e.g., by evaluating a cosine similarity). In some cases, the topic disambiguation model 210 includes a model such as a large language model, a cross encoder, a semantic similarity model, an encoder/decoder model, or a retriever model. In particular, in certain embodiments, the topic disambiguation model 210 refers to a machine learning model that generates the topic-to-topic mapping 212 between the verbatim-derived topics 204 and the context-driven topics 206.

As mentioned, in some embodiments, the topic optimization system 106 determines, identifies, or otherwise receives context-driven topics associated with a particular context or interest—independent of the aforementioned verbatim-derived topics and associated verbatims. For example, FIG. 3 illustrates an overview of the topic optimization system 106 generating context-driven topics 306 based on contextual information (e.g., related to a particular user, customer, industry, or other target schema), including context features 302 and context data 304.

As shown in FIG. 3, examples of the context features 302 include but are not limited to industry-related considerations (e.g., attributes or characteristics of a particular industry), organization-related considerations (e.g., attributes or characteristics of a particular organization), and specific user-selected features (e.g., background information provided by a particular user). Relatedly, examples the context data 304 include but are not limited to sample verbatims (e.g., verbatims known to portray particular topics of interest to an industry, organization, or user) and specific topics of interest preemptively identified for consideration by the context-driven topic model 310.

As also shown in FIG. 3, the topic optimization system 106 utilizes a context-driven topic model 310 to determine the context-driven topics 306 based on the context features 302 and the context data 304. In some cases, the context-driven topic model 310 includes or refers to a machine learning model as described above. In some cases, the context-driven topic model 310 comprises a natural language processing model, such as a large language model, configured to identify one or more topics based on the input context features 302 and/or the input context data 304 (e.g., via a custom prompt). Alternatively, in some cases, the context-driven topics 306 are provided to the topic optimization system 106 by a user or a third-party system. In some embodiments, periodic and/or event-driven updates can be made to the context features 302, the context data 304, the context-driven topic model 310, and/or the context-driven topics 306. In particular, such updates can be implemented independent of the other topic extraction pipelines described herein (e.g., in relation to FIGS. 4A-4B).

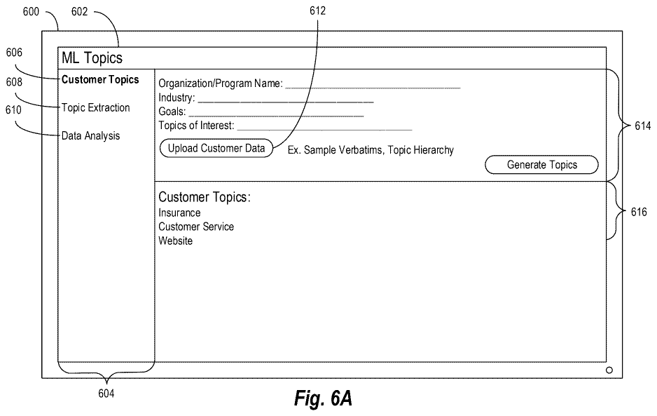

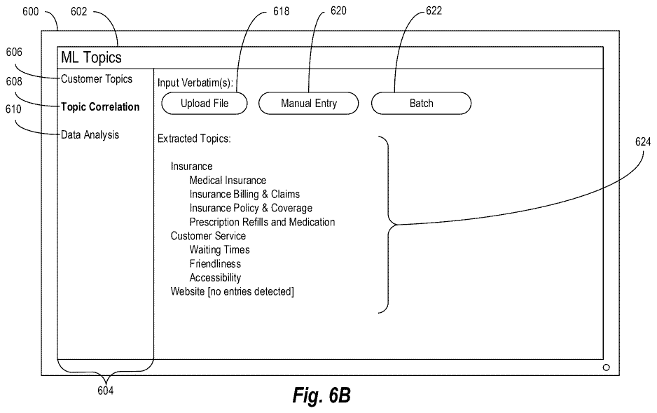

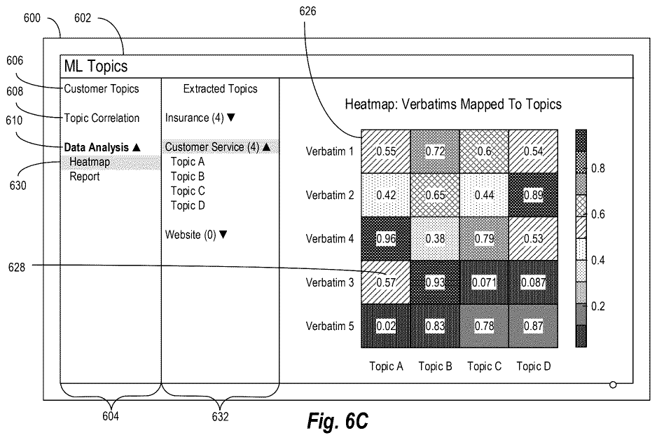

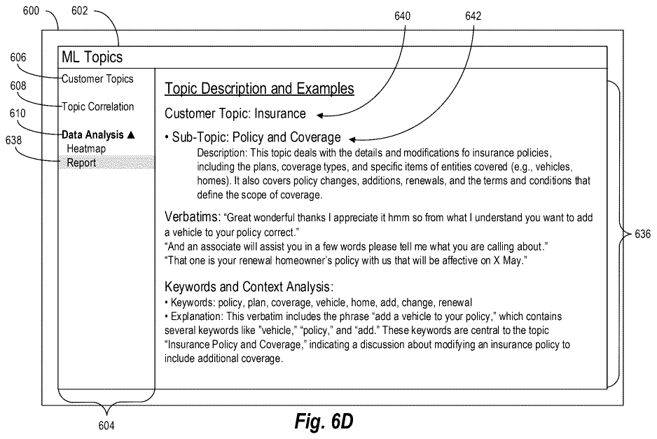

As noted above, in some cases, the topic optimization system 106 determines (or receives) a topic hierarchy 308 of the context-driven topics 306. As illustrated, for example, the topic hierarchy 308 comprises a list of the context-driven topics 306 organized according to low-level topics nested beneath at least one high-level topic. In other words, the topic hierarchy can include a relatively broad high-level topic with one or more relatively narrow low-level topics nested beneath (e.g., as illustrated in FIG. 6B).

As mentioned, in some embodiments, the topic optimization system 106 extracts (or otherwise receives) verbatim-driven topics from one or more verbatims (e.g., unstructured natural language text) utilizing a natural language processing model, such as a large language model. For example, FIG. 4A illustrates an overview of the topic optimization system 106 extracting verbatim-derived topics 408 from one or more verbatims 402 utilizing a topic extraction model 410.

As shown in FIG. 4A, the topic optimization system 106 utilizes a topic prompt 404 to cause the topic extraction model 410 to generate a verbatim dataset 406 comprising the verbatim-derived topics 408. For example, the topic optimization system 106 generates the topic prompt 404 as an input to the topic extraction model 410 to instruct the topic extraction model 410 to generate the verbatim dataset 406 from the one or more verbatims 402. For example, based on the topic prompt 404, the topic extraction model 410 generates the verbatim-derived topics 408 by determining underlying themes within the verbatims 402. In some cases, based on the topic prompt 404, the topic extraction model 410 generates the verbatim-derived topics 408 by identifying semantic similarities and co-occurrences of underlying themes within the verbatims 402. As illustrated, based on the topic prompt 404, the topic extraction model 410 generates the verbatim dataset 406 to include the verbatim-derived topics 408 and associated keywords, summaries, examples, descriptions, and/or sentiments. Further, in some cases, the topic optimization system 106 correlates the verbatim-derived topics 408 with individual verbatims for indication within the verbatim dataset 406.

As an example, in some embodiments, the topic optimization system 106 utilizes a topic prompt 404 such as the following:

Here is a list of customer comments, in <sentences></sentences>XML tags:
<sentences>
{}
</sentences>

Follow These Steps:
1. Please extract at least 5 top topics being discussed in the customer comments.
2. For each topic provide at least 7 keywords that describe the topic.
3. For each topic provide a summary headline stating what the customers are saying about the topic.
4. For each topic, please extract 4 word-for-word quotes from the human input that provide best justification for the topic summary. Do not generate any new examples. Provide it within the <examples></examples>tag.
5. For each topic provide a list of 3 sentences describing the customer comments on the topic. Provide it within the <description></description>tag.
6. For each topic identify the sentiment. Sentiment categories are as follows: “Very Negative”, “Negative”, “Mixed”, “Neutral”, “Positive”, “Very Positive”.
7. After extracting all topics, please summarize the comments, we want a paragraph giving some valuable details at a high level to set context for the user. Provide it within the <summary></summary>tag.
8. After extracting all topics, please generate a one line headline for the summary. You can include up to 2 themes and majority sentiment of customer comments in this headline. Frame it as a short and informative single sentence. Provide it within the <title></title>tag.
9. Use the following output format:

### Output Format

Topic: name of topic
Keywords: keywords associated with topic
Summary: summary of topic
<examples>
1. customer comment 1
2. customer comment 2
3. customer comment 3
4. customer comment 4
</examples>
<description>
customer description 1
customer description 2
customer description 3
</description>
p Sentiment: sentiment of topic
<summary>Overall summary</summary>
<title>Overall title</title>
Assistant:

Accordingly, as illustrated in FIG. 4A, the topic extraction model 410 generates the verbatim dataset 406 including keywords which incorporate specific words or phrases identifying the concepts related to each of the verbatim-derived topics 408 based on the topic prompt 404. In some cases, the topic extraction model 410 generates the verbatim dataset 406 including summaries which incorporate concise overviews of the verbatim-derived topics 408 and outlines of the main points. In some cases, the topic extraction model 410 generates the verbatim dataset 406 including headlines which incorporate brief and attention-grabbing titles or phrases. In some cases, the topic extraction model 410 generates the verbatim dataset 406 including examples which incorporate instances or sample verbatims that illustrate the verbatim-derived topics 408 in a practical context (e.g., how the topic is applied or manifested in real-world situations). In some cases, the topic extraction model 410 generates the verbatim dataset 406 including descriptions which incorporate detailed explanations of the verbatim-derived topics 408. In some cases, the topic extraction model 410 generates the verbatim dataset 406 including sentiments which capture the emotional tone or opinion related to the verbatim-derived topics 408 (e.g., positive, negative, neutral, or mixed).

In some embodiments, the topic optimization system 106 utilizes the topic extraction model 410 to determine the verbatim dataset 406 for subsets of the verbatims 402. For example, the topic extraction model 410determines a first subset of verbatim-derived topics from a first subset of the verbatims 402 and determines a second subset of verbatim-derived topics from a second subset of the verbatims 402. The topic optimization system 106 generates the verbatim-derived topics 408 (and corresponding content of the verbatim dataset 406) by combining the first subset of verbatim-derived topics and the second subset of verbatim-derived topics and removing (e.g., deduping) duplicate topics.

In some embodiments, the topic optimization system 106 fine-tunes the verbatim-derived topics 408 and/or the verbatim dataset 406 utilizing a refined prompt 412. For example, the topic optimization system 106 can utilize the topic extraction model 410 to extract the verbatim-derived topics 408 from the verbatims 402 (each topic associated with one or more keywords). In turn, the topic optimization system 106 generates the refined prompt 412 to cause the topic extraction model 410 to generate a subset of the verbatim-derived topics 408 based on a relative semantic similarity of the verbatim-derived topics 408 to the verbatims 402. In this way, the topic optimization system 106 guides the topic extraction model 410 to focus on specific aspects of the verbatim-derived topics 408 that are more semantically relevant to the verbatims 402. To illustrate, in some cases, the topic extraction model 410 generates a subset of the verbatim-derived topics 408 with a semantic similarity greater than 0.60. As another example, in some cases, the topic extraction model 410 generates a subset of the verbatim-derived topics 408 by selecting the top third of the verbatim-derived topics 408 based on a relative semantic similarity.

In some embodiments, the topic optimization system 106 iteratively refines the verbatim dataset 406 to expand or collapse the verbatim-derived topics 408. For example, the topic optimization system 106 utilizes the topic extraction model 410 to extract topics from the verbatims 402 wherein the topics are identified as either too expansive (covering too broad a range of content) or too specific (narrowly focused on minor details) for the needs of the system or the relevant party. As a result, the topic optimization system 106 generates the refined prompt 412 to cause the topic extraction model 410 to iteratively refine the verbatim dataset 406 by providing the refined prompt 412 (and the verbatim-derived topics 408) to the topic extraction model 410. In some cases, the topic optimization system 106 generates the refined prompt 412 to cause the topic extraction model 410 to modify the verbatim dataset 406 by expanding at least one of the verbatim-derived topics 408 into sub-topics. In some cases, the topic optimization system 106 generates the refined prompt 412 to cause the topic extraction model 410 to modify the verbatim dataset 406 by collapsing the verbatim-derived topics 408 by combining one or more of the verbatim-derived topics 408.

To illustrate, the topic extraction model 410 analyzes the verbatims 402 from one or more sources, such as but not limited to customer reviews, surveys, and/or social media posts. The topic extraction model 410 initially generates the verbatim-derived topics 408 to include a topic “customer service” from the verbatims 402 based on analyzing the underlying themes within the verbatims 402. The topic optimization system 106 identifies the topic “customer service” as unacceptably broad/expansive, as the topic encompasses multiple additional underlying themes, such as “response time,” “employee behavior,” and “problem resolution.” In turn, the topic optimization system 106 generates the refined prompt 412 to cause the topic extraction model 410 to expand the topic “customer service” into sub-topics. As a result, the topic extraction model 410 generates the verbatim dataset 406 by expanding the verbatim-derived topics 408 to include the more specific sub-topics of “response time” and “problem resolution” with associated keywords, summaries, descriptions, examples, and/or sentiments. Notably, in this example, the topic extraction model 410 does not generate the sub-topic of “employee behavior” (or expand other possible sub-topics for customer service) due to an analysis of the underlying themes of the verbatims 402 (e.g., a lack of verbatims 402 associated with “employee behavior”).

In some embodiments, the topic optimization system 106 utilizes the topic extraction model 410 to update the verbatim dataset 406 based on receiving additional verbatims. For example, based on receiving additional verbatims (in addition to the verbatims 402), the topic optimization system 106 provides the additional verbatims to the topic extraction model 410 to update the verbatim dataset 406. In some cases, the topic optimization system 106 updates the verbatim dataset 406 based on determining a change in the volume of verbatims (the additional verbatims and the verbatims 402) satisfies a change threshold by comparing the quantity of the additional verbatims to the quantity of the verbatims 402. In some cases, the topic optimization system 106 updates the verbatim dataset 406 based on determining the quantity of additional verbatims satisfies a change threshold based on the quantity of the additional verbatims.

To illustrate, in some embodiments, the topic extraction model 410 generates a verbatim dataset 406 such as the following:
Topic: Insurance
Sub-topic: Medical Insurance
Keywords: insurance, coverage, provider, deductible, benefits, eligibility, network
Summary: Customers are seeking information about their medical insurance coverage including eligibility, benefits, providers and deductibles.
Examples:
   ‘My boy I do not know models and your other line of the custom.’
   ‘If you would just verify your email address.’
   ‘I am calling from Firm Name LLC in sense that the request of Dr. John Doe office to verify benefits and eligibility for Jane Doe.’
   ‘I just got a hold your initials next to me and my guardian and now the MMS.’
Description:
   Customers are asking questions about their insurance eligibility and coverage
   They want to verify benefits and check on deductibles and network providers
   People are seeking clarification on claims and costs related to medical procedures
Sentiment: Neutral

As mentioned, in addition to extracting (or otherwise receiving) verbatim-derived topics, in some embodiments, the topic optimization system 106 utilizes one or more machine learning models to generate correlations between verbatim-derived topics and respective verbatims. For example, FIG. 4B illustrates the topic optimization system 106 utilizing a topic-verbatim correlation model 420 to generate correlations 422 between one or more verbatims 414 and related verbatim-derived topics 416 in accordance with one or more embodiments. Further, FIG. 4B shows the topic optimization system 106 utilizing a topic-verbatim association model 426 to generate associations 428 for the correlations 422 between the verbatims 414 and the verbatim-derived topics 416 in accordance with one or more embodiments.

As shown in FIG. 4B, the topic optimization system 106 utilizes a correlation prompt 418 to cause the topic-verbatim correlation model 420 to generate the correlations 422 between the verbatims 414 and the verbatim-derived topics 416. For example, based on the correlation prompt 418, the topic-verbatim correlation model 420 assigns the verbatim-derived topics 416 to the verbatims 414 by determining the correlations 422 between the verbatim-derived topics 416 and the verbatims 414. For example, the topic-verbatim correlation model 420 determines the correlations 422 based on determining a threshold semantic similarity metric reflecting a semantic relevance of the verbatim-derived topics 416 to the verbatims 414.

In some embodiments, the topic-verbatim correlation model 420 includes one or more large language models trained to recognize the verbatim-derived topics 416 within the verbatims 414 based on semantic associations between the verbatims 414 and the verbatim-derived topics 416. For example, the topic-verbatim correlation model 420 can include a model such as a zero-shot semantic similarity model, a large language model, a cross encoder, a semantic similarity model, an encoder/decoder model, and/or a retriever model. In some cases, the topic optimization system 106 selects and trains the topic-verbatim correlation model 420 based on a target language to generate the correlations 422 between the verbatims 414 and the verbatim-derived topics 416 across the target language.

In some embodiments, the topic-verbatim correlation model 420 includes a zero-shot semantic similarity model designed to categorize text data into predefined categories without requiring any prior training on labeled examples of those categories. In some cases, for example, instead of learning from examples, the topic optimization system 106 utilizes a zero-shot semantic similarity model for the topic-verbatim correlation model 420 to leverage an understanding of language and context to make predictions (e.g., by evaluating a cosine similarity). By utilizing a zero-shot semantic similarity model, the topic optimization system 106 can determine the correlations 422 for the verbatims 414 even when the topic-verbatim correlation model 420 has not previously encountered similar examples (e.g., by adapting to new verbatims).

In some embodiments, the topic optimization system 106 utilizes a large language model as the topic-verbatim correlation model 420. The large language model is designed to understand the context and nuances of the natural language text of the verbatims 414. In some cases, for example, the topic-verbatim correlation model 420 utilizes a large language model trained on vast amounts of textual content to understand and generate human-like text. In some cases, the topic optimization system 106 utilizes a large language model as the topic-verbatim correlation model 420 to generate detailed and contextually relevant topics (e.g., the verbatim-derived topics 416) from complex textual content within the verbatims 414, thereby improving the accuracy and depth of the analysis.

In some embodiments, the topic optimization system 106 utilizes the topic-verbatim correlation model 420 as a cross encoder model to generate precise similarity measurements. In some cases, for example, the topic optimization system 106 utilizes a cross encoder model to process pairs of sentences or text segments together to directly compute similarity scores or relevance between text pairs. In particular, the topic optimization system 106 can utilize a cross encoder model to generate precise metrics for the correlations 422 by measuring the semantic similarity between the verbatims 414 and the verbatim-derived topics 416.

In some embodiments, the topic optimization system 106 utilizes the topic-verbatim correlation model 420 as a semantic similarity model to determine the correlations 422. For example, the topic optimization system 106 utilizes a semantic similarity model to compute the similarity between two pieces of textual content based on semantic content. in some cases, for example, the topic-verbatim correlation model 420 utilizes a semantic similarity model to match the verbatims 414 to the verbatim-derived topics 416 by identifying which of the verbatims 414 are semantically related to which of the verbatim-derived topics 416. In some cases, the topic-verbatim correlation model 420 utilizes cosine similarity on embeddings to measure how close the verbatims 414 are to the verbatim-derived topics 416 in meaning.

In some embodiments, the topic optimization system 106 utilizes a topic-verbatim correlation model 420 as an encoder/decoder model to determine the correlations 422. In some cases, for example, the topic optimization system 106 utilizes an encoder/decoder model to generate summaries, translations, and analysis of verbatim-derived topics 416. In some cases, the topic-verbatim correlation model 420 utilizes an encoder/decoder model in sequence-to-sequence tasks, transforming an input sequence (encoder) into a different output sequence (decoder). In some cases, the topic optimization system 106 utilizes an encoder/decoder model to take the verbatims 414 as input and produce concise topic summaries or detailed topic explanations as output for the verbatim-derived topics 416.

In some embodiments, the topic optimization system 106 utilizes the topic-verbatim correlation model 420 as a retriever model to determine the correlations 422. In some cases, for example, the topic optimization system 106 utilizes a retrieval model in conjunction with embeddings to quickly find and rank relevant text segments from the verbatims 414. In some cases, the topic optimization system 106 utilizes a retrieval model to identify the most relevant verbatims of the verbatims 414 for a given topic of the verbatim-derived topics 416.

In some embodiments, the topic optimization system 106 utilizes a combination of models to generate the correlations 422 and the associations 428 for the verbatim-derived topics 416. In some cases, for example, the topic optimization system 106 utilizes a combination of the zero-shot semantic similarity model, the large language model, the cross encoder model, the semantic similarity model, the encoder/decoder model, and/or the retriever model as outlined above. In particular, in certain embodiments, the topic-verbatim correlation model 420 shown in FIG. 4B refers to a combination of one or more of the zero-shot semantic similarity model, the large language model, the cross encoder model, the semantic similarity model, the encoder/decoder model, and/or the retriever model.

As an illustrative example, in one or more embodiments, the topic optimization system 106 utilizes a large language model to generate the verbatim-derived topics 416 from the verbatims 414. In turn, the topic optimization system 106 utilizes a cross encoder model to evaluate the semantic similarity between the verbatim-derived topics 416 and the verbatims 414, optionally refining the topics 416 as described above. Furthermore, the topic optimization system 106 can utilize a zero-shot semantic similarity model to categorize new verbatims into the verbatim-derived topics 416 (e.g., the refined topics). In addition, the topic optimization system 106 can utilize an encoder/decoder model to generate real-time updates to the verbatim-derived topics 416 for additional verbatims (e.g., newly received verbatims).

As shown in FIG. 4B, in some embodiments, the topic optimization system 106 utilizes a combination of the topic-verbatim correlation model 420 and the topic-verbatim association model 426. For example, the topic optimization system 106 generates an association prompt 424 as an input to the topic-verbatim association model 426 to instruct the topic-verbatim association model 426 to generate the associations 428 from the correlations 422. For example, based on the association prompt 424, the topic-verbatim association model 426 generates the associations 428 by evaluating the correlations 422 to determine the applicability of the correlations 422, determining a relative importance and respective weights for the correlations 422.

As illustrated, for example, the topic-verbatim association model 426 generates the associations 428 as a tool to enhance the understanding and interpretation of the correlations 422. In some cases, based on the association prompt 424, the topic-verbatim association model 426 generates the associations 428 to include explanations 4230, a heatmap 432, attention weights 434, and reports 436. For example, the topic-verbatim association model 426 generates the explanations 430 which include detailed explanations for why the correlations 422 are determined as matches between the verbatims 414 and the verbatim-derived topics 416. In some cases, the topic-verbatim association model 426 generates the heatmap 432, which identifies which of the verbatims 414 are most strongly associated with specific verbatim-derived topics to identify patterns and areas of focus. In some cases, the topic-verbatim association model 426 generates the attention weights 434 to identify which of the correlations 422 are more significant and prioritize certain of the verbatims 414 or the verbatim-derived topics 416. In some cases, the topic-verbatim association model 426 generates the reports 436 to compile the correlations 422 and provide insights into the correlations 422, including summaries, examples, and analysis.

To illustrate, in one or more embodiments, the topic optimization system 106 analyzes customer feedback as depicted in FIG. 4B. For example, the topic optimization system 106 generates the correlation prompt 418 to cause the topic-verbatim correlation model 420 to identify the correlations 422 between customer comments (e.g., the verbatims 414) and common issues or praise (e.g., the verbatim-derived topics 416). Having generated the correlations 422, the topic optimization system 106 utilizes the association prompt 424 to cause the topic-verbatim association model 426 to evaluate the correlations 422, thus generating the associations 428.

As an illustrative example, the topic-verbatim association model 426 determines that comments about “delivery time” have a strong correlation with negative sentiments (e.g., common issues). As a result, the topic optimization system 106 assigns a high value within the attention weights 434 to the correlations 422 associated with “delivery time.” The topic optimization system 106 can also generate the heatmap 432 providing a visual depiction of the strong negative correlation between verbatims 414 associated with “delivery time” and customer satisfaction. Moreover, the topic optimization system 106 can generate and display the attention weights 434 to indicate that “delivery time” is a critical area for improvement. Furthermore, the topic optimization system 106 can provide the reports 436 to summarize the findings about the verbatims 414 associated with “delivery time” and/or suggests actions.

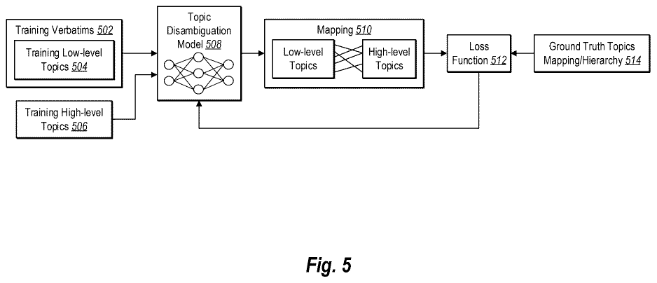

As mentioned, in some embodiments, the topic optimization system 106 utilizes a trained language processing model, such as a large language model, to generate a mapping between high-level topics (e.g., context-driven topics) generated or otherwise identified for a particular context or interest and low-level topics (e.g., verbatim-derived topics) derived from one or more input verbatims. To further illustrate, FIG. 5 shows the topic optimization system 106 training a topic disambiguation model 508 to generate mappings of low-level topics to high-level topics according to one or more embodiments.

As shown in FIG. 5, the topic optimization system 106 trains the topic disambiguation model 508 to generate a mapping 510 of low-level topics to high-level topics. For example, the topic optimization system 106 provides training low-level topics 504 (e.g., topics extracted from or otherwise identified for training verbatims 502) and training high-level topics 506 (e.g., broader topics relative to the training low-level topics 504) to the topic disambiguation model 508. Using multiple training iterations, the topic optimization system 106 determines a loss from a loss function 512 based on a comparison of the mapping 510 with a ground truth topics mapping 514 (e.g., a ground truth hierarchy of topics with low-level topics nested beneath high-level topics). In turn, the topic optimization system 106 performs subsequent training iterations for the training low-level topics 504 and the training high-level topics 506.

To elaborate, in an initial training iteration, the topic optimization system 106 inputs the training low-level topics 504 and the training high-level topics 506 into the topic disambiguation model 508. As part of such input, in some embodiments, the topic optimization system 106 parses and tokenizes the training low-level topics 504 and the training high-level topics 506, and subsequently inputs the tokens into the topic disambiguation model 508. Upon receipt the input tokens, the topic disambiguation model 508 generates the mapping 510 of the training low-level topics 504 to the training high-level topics 506 of the initial training iteration. In some embodiments, for instance, the topic disambiguation model determines an encoded and context-away representation for the textual content within the training low-level topics 504 and the training high-level topics 506. Based on the encoded and context-aware representation for the textual content, the topic disambiguation model 508 generates the mapping 510.

As further indicated in FIG. 5, the topic optimization system 106 determines a loss according to the loss function 512 based on a comparison of the mapping 510 with the ground truth topics mapping 514. In some embodiments, when training the topic disambiguation model 508, the topic optimization system 106 uses the ground truth topics mapping 514 as a reference point to determine the loss according to the loss function 512. In some embodiments, the topic optimization system 106 uses a cross-entropy-loss function, an L2-loss function, a mean-absolute-error-loss function, a mean-squared-error-loss function, a root-mean-squared-error function, or other suitable loss function as the loss function 512 to compare the mapping 510 and the ground truth topics mapping 514 and to determine a loss therebetween.

Upon determining a loss according to the loss function 512, the topic optimization system 106 adjusts the network parameters (e.g., weights or values) of the topic disambiguation model 508 to decrease the loss according to the loss function 512 in a subsequent training iteration. For example, the topic optimization system 106 may increase or decrease weights or values of the topic disambiguation model 508 to minimize the loss in a subsequent training iteration.

As also shown in FIG. 5, after adjusting the network parameters of the topic disambiguation model 508, the topic optimization system 106 performs additional training iterations until satisfying a convergence criteria. For example, the topic optimization system 106 can iteratively provide the training low-level topics 504, the training high-level topics 506, and the ground truth topics mapping 514 to the topic disambiguation model 508 to generate the mapping 510, iteratively determine losses according to the loss function 512 based on comparisons of the mapping 510 with the ground truth topics mapping 514, and iteratively adjust the parameters of the topic disambiguation model 508 based on the determined losses. In some cases, the topic optimization system 106 performs training iterations until the values or weights of the topic disambiguation model 508 do not change significantly across training iterations (e.g., when parameter changes fall below a threshold change metric).

As mentioned, in some embodiments, the topic optimization system 106 provides data extraction results, such as topic/verbatim correlations and analytics of textual data within a graphical user interface on a computing device. For example, FIGS. 6A-6D illustrate the topic optimization system 106 providing results of topic extraction, correlation, and disambiguation for display within a graphical user interface of a computing device 600 (e.g., computing device 102, computing device 900, or another device described herein) in accordance with one or more embodiments. Rather than refer to a particular computer application or the topic optimization system 106 as performing the actions depicted in FIGS. 6A-6D, this disclosure will generally refer to the computing device 600 performing such actions for simplicity.

As illustrated in FIG. 6A, the computing device 600 displays within the user interface 602 an application interface for generating and displaying customer topics 616 (e.g., context-driven topics) based on user inputs 614 (e.g., as described above in relation to FIG. 3). As mentioned, in some embodiments, the topic optimization system 106 generates context-driven topics (e.g., the customer topics 616) based on contextual information related to a particular industry or organization (e.g., a “customer”).

As shown in FIG. 6A, the computing device 600 displays an application menu 604 comprising a first selectable menu item 606 entitled “Customer Topics”, a second selectable menu item 608 entitled “Topic Extraction”, and a third selectable menu item 610 entitled “Data Analysis”. As illustrated, with the first selectable menu item 606 selected (e.g., by user interaction with the selectable menu item 606), the computing device 600 provides a display area for entering and/or uploading the user inputs 614, including contextual information for generating the customer topics 616.

In addition to various prompts for entering contextual information (e.g., for manual entry of context features as described above in relation to FIG. 3), the display area includes a selectable option 612 for uploading customer data (e.g., context data as described above in relation to FIG. 3). For example, a user can upload, via the selectable option 612, a user-provided topic hierarchy comprising known topics of interest. Alternatively or additionally, the user can upload, via the selectable option 612, one or more sample verbatims indicative of the user's interests (e.g., an exemplary verbatim addressing multiple topics related to the customer's industry or other interests).

As also shown in FIG. 6A, the computing device 600 displays the customer topics 616 determined based on the user inputs 614 provided to the topic optimization system 106 via the computing device 600. In some cases, for example, the user directly uploads the customer topics 616 to the computing device 600 (e.g., via the selectable option 612). Moreover, the user can enter or upload the requested information and permit the topic optimization system 106 to generate the customer topics 616 in an automated manner. As illustrated, the computer device displays multiple high-level topics, including “insurance,” “customer service,” and “website.” At this point, the user can either accept the provided customer topics 616 or modify the customer topics 616 by adding topics of particular interest to the user or deleting unwanted topics from the customer topics 616.

As illustrated in FIG. 6B, the computing device 600 displays within the user interface 602 an application interface for extracting verbatim-derived topics from input verbatims and providing a mapping of the extracted verbatim-level topics to context-driven topics (e.g., the customer topics 616) in a topic hierarchy 624. As mentioned, in some embodiments, the topic optimization system 106 generates verbatim-derived topics conveying underlying themes of one or more input verbatims. Further, in some embodiments, the topic optimization system 106 generates a verbatim dataset comprising the verbatim-derived topics, as well as associated content, such as keywords, summaries, descriptions, example, sentiments, and so forth.

As shown in FIG. 6B, with the second selectable menu item 608 (denoted “Topic Correlation”) selected within the application menu 604 (e.g., by user interaction with the second selectable menu item 608), the computing device 600 provides a display area for user input of verbatims from which verbatim-derived topics are to be extracted. To illustrate, the topic optimization system 106 generates verbatim-derived topics utilizing verbatims uploaded in files (e.g., via user interaction with a first selectable option 618), input manually (e.g., via a user interaction with a second selectable option 620), added in batches (e.g., via user interaction with a third selectable option 622), and/or utilizing other input methods. In some cases, the topic optimization system 106 iteratively refines the verbatim-derived topics to expand the verbatim-derived topics into additional sub-topics or by combining concepts (e.g., more specific sub-topics) to generate the verbatim-derived (e.g., as discussed above in relation to FIG. 4A). Furthermore, as shown in FIG. 6B, the topic optimization system 106 incorporates the verbatim-derived topics into the predefined context-driven topics (e.g., the customer topics 616) to generate and display the topic hierarchy 624.

In particular, the topic optimization system 106 provides the topic hierarchy 624 including the customer topics 616 (“Insurance”, “Customer Service”, and “Website”) as well as the associated verbatim-derived topics for display on the computing device 600. As shown, the topic hierarchy 624 includes the verbatim-derived topics of “Medical Insurance”, “Insurance Billing & Claims”, “Insurance Policy & Coverage”, and “Prescription Refills and Medication” nested beneath the customer topic of “Insurance”. Also, the topic hierarchy 624 includes the verbatim-derived topics of “Waiting Times”, “Friendliness”, and “Accessibility” nested beneath the customer topic of “Customer Service”. As also shown in FIG. 6B, the topic hierarchy 624 includes the customer topic of “Website” but indicates that no references to the topic were detected within the verbatims input for extraction of verbatim-derived topics. While not shown in the example illustrated by FIG. 6B, in some cases, a high-level verbatim-derived topic not included within the context-driven topics (e.g., not included in the customer topics 616) may be extracted from input verbatims and included within the results as a high-level topic (e.g., not nested beneath another topic).

In some embodiments, the topic optimization system 106 can generated visual representations highlighting the strength and importance of correlations between verbatims and corresponding topics, including both verbatim-derived topics and context-driven topics. For example, FIG. 6C illustrates the topic optimization system 106 providing, for display on the computing device 600, a heatmap representing correlations between verbatims and selected topics in accordance with one or more embodiments.

As illustrated in FIG. 6C, the computing device 600 displays within the user interface 602 an application interface for displaying visual representations corresponding to high-level and low-level topics of the topic hierarchy 624. In particular, with the third selectable menu item 610 (denoted “Data Analysis”) and a selectable sub-menu item 630 (denoted “Heatmap”) selected within the application menu 604 (e.g., by user interaction with the second selectable menu item 608 and the selectable sub-menu item 630), the computing device 600 provides an additional application menu 632 for viewing heatmaps associated with different topics of the topic hierarchy 624. As shown, with the customer topic “Customer Service” selected within the additional application menu 632, the computing device 600 displays a heatmap 626 of verbatims mapped to sub-topics of the selected customer topic (e.g., verbatim-derived topics mapped to the selected context-driven topic).

As shown in FIG. 6C, the computing device 600 displays the heatmap 626 of verbatims mapped to sub-topics of the selected topic of “Customer Service”. For example, the topic optimization system 106 determines cosine similarities between encoded verbatims and topics to obtain a similarity metric. In some cases, the topic optimization system 106 displays (e.g., via the computing device 600) the similarity matrix as a heatmap, where rows of the heatmap correspond to verbatims and columns correspond to topics. In some cases, the topic optimization system 106 utilizes a cell color intensity or cell crosshatching to indicate the magnitude of the similarity between the verbatims and the topics. For example, the topic optimization system 106 can utilize a darker color to visually represent a higher similarity metric and a lighter color to represent a lower similarity metric for the corresponding verbatim/topic correlation.

As also shown in FIG. 6C, the computing device 600 displays attention weights for the correlations between the verbatims and the topics. For example, the topic optimization system 106 provides a granular analysis of the similarity scores within the heatmap 626 utilizing attention weights. To illustrate, the computing device 600 displays an attention weight 628 of 0.57 for the correlation between Verbatim 3 and Topic A. In particular, the attention weight 628 represents a similarity value greater than half (e.g., more similar than not), where 1.0 indicates perfect similarity and 0.0 indicates no similarity.

To illustrate, via the heatmap 626, the topic optimization system 106 provides a visual tool within the interface 602 for rapid identification of strong correlations between verbatims and topics. In this way, the topic optimization system 106 provides a visual indication of patterns and areas of interest among the verbatims, linked directly to both context-driven topics and associated verbatim-derived topics of the topic hierarchy 624. Through this visual representation of the strengths between various correlations, the topic optimization system 106 provides a visual indication of the relevancy of various topics and a visual aid to interpret the correlations. To illustrate, based on the heatmap 626, the topic optimization system 106 provides a visual indication that Topic A is most relevant to Verbatim 4 (with an attention weight of 0.96 and a dark color cell), whereas Topic B is least relevant to Verbatim 4 (with an attention weight of 0.38 and a lighter color cell).

Moreover, in some embodiments, the topic optimization system 106 provides explanatory reports for display on client devices. For example, FIG. 6D illustrates the topic optimization system 106 providing, for display on the computing device 600, an explanatory report for correlations between a verbatim and a topic in accordance with one or more embodiments.

As illustrated in FIG. 6D, the computing device 600 displays within the user interface 602 an application interface for displaying explanatory reports corresponding to topics of the topic hierarchy 624. In particular, with the third selectable menu item 610 (denoted “Data Analysis”) and a selectable sub-menu item 638 (denoted “Report”) selected within the application menu 604 (e.g., by user interaction with the second selectable menu item 608 and the selectable sub-menu item 638), the computing device 600 provides an explanatory report 636 related to the verbatim-derived topic 642 of “Policy and Coverage,” which the topic optimization system 106 has mapped to the high-level customer topic 640 of “Insurance” within the topic hierarchy 624.

As shown in FIG. 6D, via the explanatory report 636 displayed within the interface 602 of the computing device 600, the topic optimization system 106 provides concrete examples of verbatims that are strongly correlated with a particular topic as well as reasons that certain verbatims are classified under the particular topic. For example, the explanatory report 636 includes a detailed explanation of the particular topic, as well as associated verbatims, description, keywords, explanations, and/or associated textual content.

Moreover, in one or more embodiments, the topic optimization system 106 provides additional explanatory reports offering a deeper understanding of the classification process. For example, the topic optimization system 106 provides an Overview Report including a high-level summary of the analysis of correlations between context-driven topics and verbatim-derived topics and/or between verbatims and topics, including the overall accuracy of the topic classifications. In this way, the topic optimization system 106 can provide a correlated report identifying common issues or categorizing verbatims and/or topics. As another example, the topic optimization system 106 provides a Sentiment Analysis Report including an analysis of the sentiment associated with each topic, indicating whether the associated verbatims express positive, negative, neutral, or mixed sentiments. Relatedly, the topic optimization system 106 can provide graphs or charts showing how sentiments vary across different topics or over time. As another example, the topic optimization system 106 can provide a Recommendation Report including practical recommendations suggesting specific actions or strategies to address the identified issues or leverage positive feedback. In some cases, the topic optimization system 106 provides suggested next steps for further analysis or follow-up actions to improve the overall understanding and/or response to the correlations.

Utilizing explanatory reports, the topic optimization system 106 can provide a comprehensive explanation of the correlation between verbatims and topics or the mapping of verbatim-derived topics to context-driven topics. In particular, the topic optimization system 106 enhances the transparency and understanding of the underlying reasons for the correlations between the topics and the verbatims and/or the mapping of verbatim-derived topics to context-driven topics. By providing a variety of reports, the topic optimization system 106 provides means for accurately utilizing the correlations and mapping and enables sophisticated, data-driven decisions.

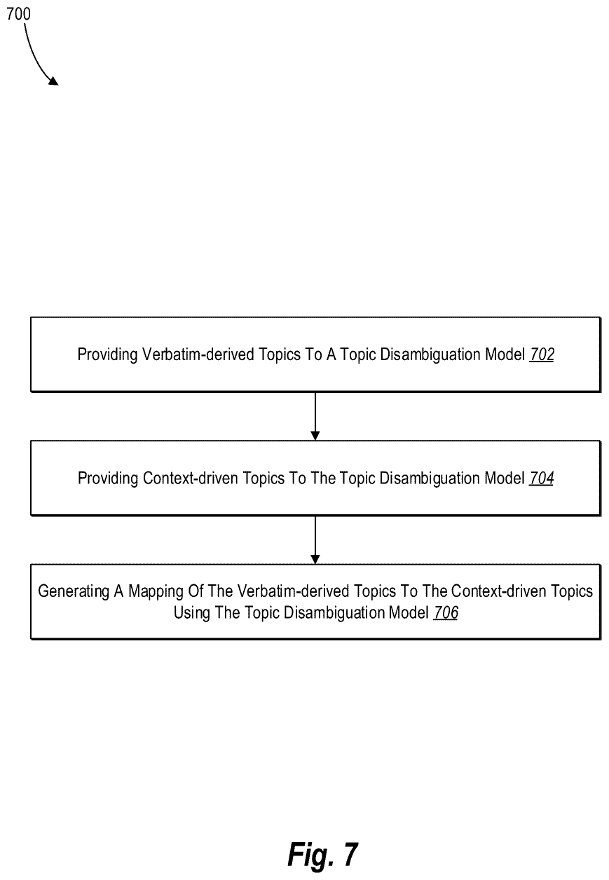

Turning now to FIG. 7, this figure illustrates a flowchart of a series of acts 700 for generating a mapping between verbatim-derived topics and context-driven topics in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable storage medium can comprise instructions that, when executed by one or more processors, cause a computing device to perform the acts depicted in FIG. 7. In still further embodiments, a system can perform the acts of FIG. 7.

As shown in FIG. 7, the series of acts 700 includes an act 702 of providing verbatim-derived topics to a topic disambiguation model. In particular, in some embodiments, the act 702 includes providing, to a topic disambiguation model, a dataset of verbatim-derived topics determined from one or more verbatims by a topic extraction model, the one or more verbatims comprising natural language user input text.

As further shown in FIG. 7, the series of acts 700 includes an act 704 of providing context-driven topics to the topic disambiguation model. In particular, in some embodiments, the act 704 includes providing, to the topic disambiguation model, one or more context-driven topics identified independent of the one or more verbatims of the dataset of verbatim-derived topics.

As further shown in FIG. 7, the series of acts 700 includes an act 706 of generating a mapping of the verbatim-derived topics to the context-driven topics using the topic disambiguation model. In particular, in some embodiments, the act 706 includes generating, utilizing the topic disambiguation model, a mapping of verbatim-derived topics from the dataset of verbatim-derived topics to the one or more context-driven topics.

In addition to the acts 702-706, the series of acts 700 may include additions or variations. In certain implementations, for instance, the acts 700 includes generating, utilizing the topic extraction model, the dataset of verbatim-derived topics independent of the one or more context-driven topics. In some embodiments, the topic extraction model comprises a large language model trained to generate a plurality of topics and related keywords based on a plurality of verbatims, the plurality of topics conveying underlying themes of the plurality of verbatims. Also, in some embodiments, the series of acts 700 includes generating, utilizing a topic-verbatim correlation model, correlations between topics and keywords of the dataset of verbatim-derived topics and individual verbatims of the one or more verbatims.

Further, in one or more embodiments, the one or more context-driven topics comprise a topic hierarchy of low-level topics nested beneath at least one high-level topic. In some embodiments, the series of acts 700 includes determining the one or more context-driven topics based on contextual information associated with one or more of a particular industry, a particular organization, a user-provided set of verbatims, or user-provided topics of interest. Also, in some embodiments, the series of acts 700 includes determining the one or more context-driven topics utilizing context-driven topic model trained to determine one or more topics based on inputs including one or more of contextual information or context-specific verbatims.

Moreover, in one or more embodiments, the series of acts 700 includes updating the one or more context-driven topics in response to receiving additional contextual information or context-specific verbatims and generating, utilizing the topic disambiguation model, a mapping of the verbatim-derived topics from the dataset of verbatim-derived topics to the updated one or more context-driven topics. In some embodiments, the topic disambiguation model comprises a large language model trained to generate mappings of input low-level topics to input high-level topics based on semantic associations between the input low-level topics and the input high-level topics. Also, in one or more embodiments, the series of acts 700 includes assigning at least one context-driven topic of the one or more context-driven topics to a respective verbatim of the one or more verbatims based on the mapping of verbatim-derived topics to the one or more context-driven topics.

Furthermore, in some embodiments, the series of acts 700 includes generating, utilizing a topic-verbatim correlation model, correlations between verbatim-derived topics of the dataset of verbatim-derived topics and individual verbatims of the one or more verbatims. In one or more embodiments, the series of acts 700 further includes assigning at least one context-driven topic of the one or more context-driven topics to a respective verbatim of the one or more verbatims based on the mapping of verbatim-derived topics to the one or more context-driven topics and the correlations between the verbatim-derived topics of the dataset of verbatim-derived topics and the individual verbatims of the one or more verbatims. Also, in some embodiments, the series of acts 700 includes receiving at least one additional context-driven topic and updating, utilizing the topic disambiguation model, the mapping of the verbatim-derived topics from the dataset of verbatim-derived topics to the one or more context-driven topics and the at least one additional context-driven topic.

Moreover, in one or more embodiments, the series of acts 700 includes providing, to the topic disambiguation model, additional verbatim-derived topics determined from one or more additional verbatims by the topic extraction model and updating, utilizing the topic disambiguation model, the mapping of the verbatim-derived topics from the dataset of verbatim-derived topics to the one or more context-driven topics with an additional mapping of the additional verbatim-derived topics to the one or more context-driven topics.

Also, in some embodiments, the series of acts 700 includes identifying the one or more context-driven topics based on one or more of user-selected topics or topics generated based on user-provided contextual information and determining, in response to receiving the one or more verbatims, the dataset of verbatim-derived topics utilizing a topic extraction model. Further, in one or more embodiments, the series of acts 700 includes generating, based on the mapping of the verbatim-derived topics from the dataset of verbatim-derived topics to the one or more context-driven topics, a topic hierarchy comprising the one or more context-driven topics and the verbatim-derived topics of the dataset of verbatim-derived topics. In some embodiments, the series of acts 700 also includes generating, utilizing a topic-verbatim correlation model, correlations between the verbatim-derived topics of the dataset of verbatim-derived topics and individual verbatims of the one or more verbatims. Also, in some embodiments, the series of acts 700 includes assigning the one or more verbatims to respective topics within the topic hierarchy based on the correlations between the verbatim-derived topics of the dataset of verbatim-derived topics and the individual verbatims of the one or more verbatims.

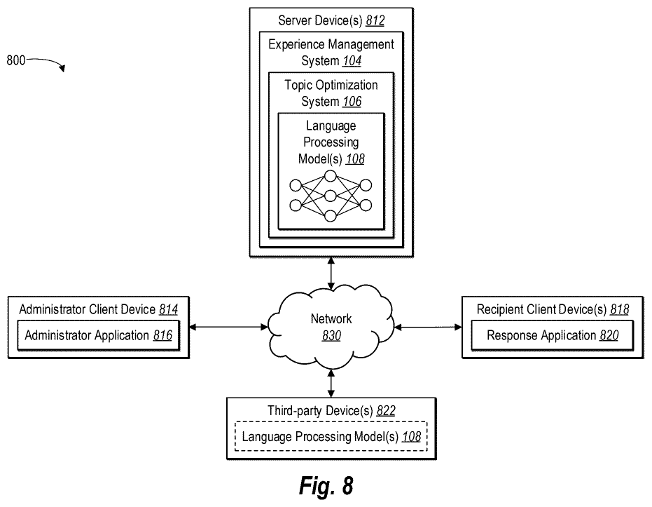

In one or more embodiments, the topic optimization system 106 operates within a computing environment. To illustrate, FIG. 8 shows a schematic diagram of an exemplary system environment (“environment”) 800 in which the experience management system 104, the topic optimization system 106, and the large language model(s) 106 (discussed in relation to FIG. 1) can operate. As illustrated in FIG. 8, the environment 800 includes one or more server device(s) 812, an administrator client device 814, one or more recipient client device(s) 818, one or more third-party device(s) 822, and a network 830.

Although the environment 800 of FIG. 8 is depicted as having a particular number and configuration of components, the environment 800 is capable of having any number or configuration of additional or alternative components (e.g., any number of server devices, client devices, or other components in communication with the topic optimization system 106 via the network 830 or by direct communication with the server device(s) 812). Similarly, although FIG. 8 illustrates a particular arrangement of the server device(s) 812, the network 830, the administrator client device 814, the recipient client device(s) 818, and the third-party device(s) 822, various alternative arrangements are possible.

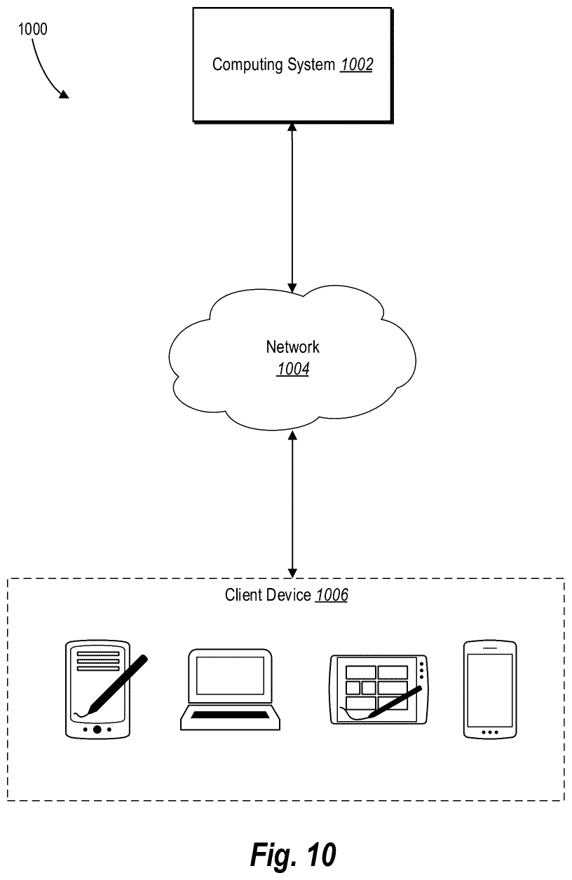

As shown in FIG. 8, the server device(s) 812, the administrator client device 814, the recipient client device(s) 818, and the third-party device(s) 822 are communicatively coupled with each other either directly or indirectly (e.g., through the network 830 or the network 1004 as further discussed below in relation to FIG. 10). Moreover, the server device(s) 812, the administrator client device 814, the recipient client device(s) 818, and the third-party device(s) 822 each include one of a variety of computing devices (including one or more computing devices as discussed in greater detail in relation to FIG. 10).

As mentioned above, the environment 800 includes the server device(s) 812. In one or more embodiments, the server device(s) 812 generates, stores, receives, and/or transmits data, including queries and informational response in response to queries, as well as contextual information and user-selected topics (e.g., as discussed above in relation to FIGS. 2-3). In one or more embodiments, the server device(s) 812 comprises a data server. In some implementations, the server device(s) 812 comprises a communication server or a web-hosting server.

As shown in FIG. 8, the server device(s) 812 includes the experience management system 104. In one or more embodiments, for example, the experience management system 104 provides functionality that facilitates the creation and distribution of electronic surveys and the collection and processing of survey responses. As previously mentioned, in some cases, the topic optimization system 106 operates as part of the experience management system 104 which, among other things, facilitates the collection and processing of data based on user interactions with digital systems.

Additionally, the server device(s) 802 include the topic optimization system 106. As discussed above, the topic optimization system 106 can generate a mapping of verbatim-derived topics extracted from one or more input verbatims to context-driven topics identified based on a particular context or otherwise provided by a user. For instance, the topic optimization system 106 can use the large language model(s) 108 to generate: (i) verbatim-derived topics by extracting themes and/or keywords from one or more input verbatims (e.g., as discussed above in relation to FIG. 4A); and/or (ii) context-driven topics based on context features and/or context data (e.g., as discussed above in relation to FIG. 3). Having received (or identified) verbatim-derived topics and context-driven topics, the topic optimization system 106 can utilize the large language model(s) 108 (e.g., a topic disambiguation model) to generate the aforementioned mapping of the verbatim-derived topics to the context-driven topics. The topic optimization system 106 can further provide a presentation regarding the results of mapping verbatim-derived topics (and/or associated verbatims) to context-driven topics.

As mentioned, in some embodiments, the administrator client device 814 and the recipient client device(s) 818 communicate with server device(s) 812 over the network 830. As described above, the server device(s) 812 can enable the various functions, features, processes, methods, and systems described herein using, for example, the topic optimization system 106. As shown in FIG. 8, the topic optimization system 106 comprises computer executable instructions that, when executed by a processor of the server device(s) 812, perform certain actions described above with reference to FIGS. 1-7. Additionally, or alternatively, in some embodiments, the server device(s) 812 coordinate with one or both of the administrator client device 814 and the recipient client device(s) 818 to perform or provide the various functions, features, processes, methods, and systems described in more detail above. Although FIG. 8 illustrates a particular arrangement of the server device(s) 812, the administrator client device 814, the recipient client device(s) 818, the third-party device(s) 822, and the network 830, various additional arrangements are possible. For example, the server device(s) 812 and the experience management system 104 may directly communicate with the administrator client device 814, bypassing the network 830.

Generally, the administrator client device 814 and recipient client device(s) 818 may be any one of various types of client devices. For example, the administrator client device 814, the recipient client device(s) 818, and the third-party device(s) 822 may be mobile devices (e.g., a smart phone, tablet), laptops, desktops, or any other type of computing devices, such as those described below with reference to FIG. 10. Additionally, the server device(s) 812 may include one or more computing devices, including those explained below with reference to FIG. 10. The server device(s) 812, the administrator client device 814, the recipient client device(s) 818, and the third-party device(s) 822 may communicate using any communication platforms and technologies suitable for transporting data and/or communication signals, including the examples described below with reference to FIG. 10.

In some cases, an administrator application 816 hosted by the administrator client device 814 and a response application 820 hosted by the recipient client device(s) 818 access the functionalities of the topic optimization system 106. In some embodiments, one or both of the administrator application 816 and the response application 820 comprise web browsers, applets, or other software applications (e.g., native applications or web applications) available to the administrator client device 814 or the recipient client device(s) 818, respectively. Additionally, in some instances, the experience management system 104 provides data packets including instructions that, when executed by the administrator client device 814 or the recipient client device(s) 818, create or otherwise integrate the administrator application 816 or the response application 820 within an application or webpage for the administrator client device 814 or the recipient client device(s) 818, respectively.

As an exemplary overview, the server device(s) 812 provide the administrator client device 814 access to the experience management system 104 and the topic optimization system 106 by way of the network 830. In one or more embodiments, by accessing the experience management system 104, the server device(s) 812 provide one or more digital documents to the administrator application 816 to enable the administrator client device 814 to correlate context-driven topics with verbatim-derived topics and/or associated verbatims. For example, the experience management system 104 can include a website (e.g., one or more webpages) or utilize the administrator application 816 to enable the administrator client device 814 to generate topics, mappings, classifications, reports, or other digital content for distribution to the recipient client device(s) 818.

In addition, while FIG. 8 illustrates the use of the experience management system 104 on the server device(s) 812 to assign topics to verbatims, the communication environment can utilize other services or devices to assign topics to verbatims. For example, the experience management system 104 can access third-party device(s) 822 including the large language model(s) 108. In some cases, the experience management system 104 accesses the large language model(s) 108 to generate verbatim-derived topics from verbatims, determine correlations between verbatims and topics, provide explanations for verbatims/topics, determine or receive context-driven topics, generate mappings of context-driven topics to verbatim-derived topics, or other features of the experience management system 104. Accordingly, various embodiments are discussed herein with respect to accessing the topic optimization system 106 (e.g., via the experience management system 104) for explanation purposes, but it is understood the principles and features described herein are applicable for execution on additional devices.

Embodiments of the present disclosure may comprise or utilize a special-purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

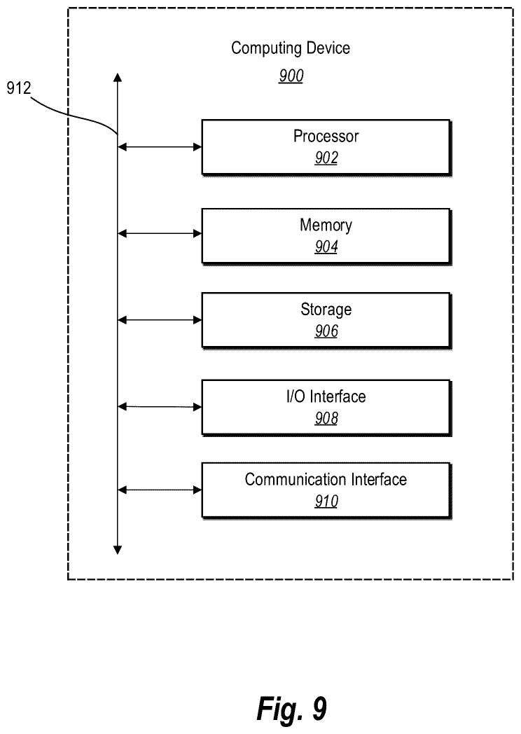

FIG. 9 illustrates a block diagram of an exemplary computing device 900 that may be configured to perform one or more of the processes described above. One will appreciate that one or more computing devices such as the computing device 900 may implement the server device(s) 102, the administrator client device 814, the recipient client device(s) 818, the third-party device(s) 822, and/or other devices described above in connection with FIG. 8. As shown by FIG. 9, the computing device 900 can comprise a processor 902, a memory 904, a storage device 906, an I/O interface 908, and a communication interface 910, which may be communicatively coupled by way of a communication infrastructure 912. While the exemplary computing device 900 is shown in FIG. 9, the components illustrated in FIG. 9 are not intended to be limiting. Additional or alternative components may be used in other embodiments. Furthermore, in certain embodiments, the computing device 900 can include fewer components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions, the processor 902 may retrieve (or fetch) the instructions from an internal register, an internal cache, the memory 904, or the storage device 906 and decode and execute them. In one or more embodiments, the processor 902 may include one or more internal caches for data, instructions, or addresses. As an example, and not by way of limitation, the processor 902 may include one or more instruction caches, one or more data caches, and one or more translation lookaside buffers (“TLBs”). Instructions in the instruction caches may be copies of instructions in the memory 904 or the storage device 906.

The memory 904 may be used for storing data, metadata, and programs for execution by the processor(s). The memory 904 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 904 may be internal or distributed memory.

The storage device 906 includes storage for storing data or instructions. As an example, and not by way of limitation, storage device 906 can comprise a non-transitory storage medium described above. The storage device 906 may include a hard disk drive (“HDD”), a floppy disk drive, flash memory, an optical disc, a magneto-optical disc, magnetic tape, or a Universal Serial Bus (“USB”) drive or a combination of two or more of these. The storage device 906 may include removable or non-removable (or fixed) media, where appropriate. The storage device 906 may be internal or external to the computing device 900. In one or more embodiments, the storage device 906 is non-volatile, solid-state memory. In other embodiments, the storage device 906 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 908 allows a user to provide input to, receive output from, and otherwise transfer data to and receive data from the computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example, and not by way of limitation, the communication interface 910 may include a network interface controller (“NIC”) or network adapter for communicating with an Ethernet or other wire-based network or a wireless NIC (“WNIC”) or wireless adapter for communicating with a wireless network, such as a WI-FI.

Additionally, or alternatively, the communication interface 910 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 910 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 912 may include hardware, software, or both that couples components of the computing device 900 to each other. As an example and not by way of limitation, the communication infrastructure 912 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

FIG. 10 illustrates an example network environment 1000 of the experience management system 104. Network environment 1000 includes the computing system 1002 and the client system 1006 connected to each other by a network 1004. Although FIG. 10 illustrates a particular arrangement of client system 1006, computing system 1002, and network 1004, this disclosure contemplates any suitable arrangement of client system 1006, computing system 1002, and network 1004. As an example, and not by way of limitation, two or more devices of the client system 1006 and the computing system 1002 may be connected to each other directly, bypassing the network 1004. As another example, two or more devices of the client system 1006 and the computing system 1002 may be physically or logically co-located with each other in whole, or in part. Moreover, although FIG. 10 illustrates a particular number of the client system 1006 devices, computing system 1002 devices, and network 1004, this disclosure contemplates any suitable number of the client system 1006 devices, computing system 1002 devices, and network 1004. As an example, and not by way of limitation, network environment 1000 may include multiple of the client system 1006 devices, computing system 1002 devices, and network 1004.

This disclosure contemplates any suitable network for the network 1004. As an example and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more of the network 1004.

Links may connect the client system 1006, and the computing system 1002 to the network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”)), wireless (such as for example Wi-Fi or Worldwide Interoperability for Microwave Access (“WiMAX”)), or optical (such as for example Synchronous Optical Network (SONET) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client system 1006 may be an electronic device including hardware, software, or embedded logic components or a combination of two or more such components and capable of carrying out the appropriate functionalities implemented or supported by the client system 1006. As an example, and not by way of limitation, the client system 1006 may include any of the computing devices discussed above in relation to FIG. 9. The client system 1006 may enable a network user at the client system 1006 to access the network 1004.

In particular embodiments, the client system 1006 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client system 1006 may enter a Uniform Resource Locator (“URL”) or other address directing the web browser to a particular server (such as server, or a server associated with a third-party system), and the web browser may generate a Hyper Text Transfer Protocol (“HTTP”) request and communicate the HTTP request to server. The server may accept the HTTP request and communicate to the client system 1006 one or more Hyper Text Markup Language (“HTML”) files responsive to the HTTP request. The client system 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the computing system 1002 may include a variety of servers, sub-systems, programs, modules, logs, and data stores. In particular embodiments, the computing system 1002 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The computing system 1002 may also include suitable components such as network interfaces, security mechanisms, load balancers, failover servers, management-and-network-operations consoles, other suitable components, or any suitable combination thereof.

In particular embodiments, the computing system 1002 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
providing, to a topic disambiguation model, a dataset of verbatim-derived topics determined from one or more verbatims by a topic extraction model, the one or more verbatims comprising natural language user input text;
providing, to the topic disambiguation model, one or more context-driven topics identified independent of the one or more verbatims of the dataset of verbatim-derived topics; and
generating, utilizing the topic disambiguation model, a mapping of verbatim-derived topics from the dataset of verbatim-derived topics to the one or more context-driven topics.

2. The method of claim 1, further comprising generating, utilizing the topic extraction model, the dataset of verbatim-derived topics independent of the one or more context-driven topics.

3. The method of claim 1, wherein the topic extraction model comprises a large language model trained to generate a plurality of topics and related keywords based on a plurality of verbatims, the plurality of topics conveying underlying themes of the plurality of verbatims.

4. The method of claim 3, further comprising generating, utilizing a topic-verbatim correlation model, correlations between topics and keywords of the dataset of verbatim-derived topics and individual verbatims of the one or more verbatims.

5. The method of claim 1, wherein the one or more context-driven topics comprise a topic hierarchy of low-level topics nested beneath at least one high-level topic.

6. The method of claim 1, further comprising determining the one or more context-driven topics based on contextual information associated with one or more of a particular industry, a particular organization, a user-provided set of verbatims, or user-provided topics of interest.

7. The method of claim 6, further comprising determining the one or more context-driven topics utilizing context-driven topic model trained to determine one or more topics based on inputs including one or more of contextual information or context-specific verbatims.

8. The method of claim 1, further comprising:
updating the one or more context-driven topics in response to receiving additional contextual information or context-specific verbatims; and
generating, utilizing the topic disambiguation model, a mapping of the verbatim-derived topics from the dataset of verbatim-derived topics to the updated one or more context-driven topics.

9. The method of claim 1, wherein the topic disambiguation model comprises a large language model trained to generate mappings of input low-level topics to input high-level topics based on semantic associations between the input low-level topics and the input high-level topics.

10. A non-transitory computer-readable medium storing instructions that, when executed by at least one processor, cause a computer device to:
provide, to a topic disambiguation model, a dataset of verbatim-derived topics determined from one or more verbatims by a topic extraction model, the one or more verbatims comprising natural language user input text;
provide, to the topic disambiguation model, one or more context-driven topics identified independent of the one or more verbatims of the dataset of verbatim-derived topics; and
generate, utilizing the topic disambiguation model, a mapping of verbatim-derived topics from the dataset of verbatim-derived topics to the one or more context-driven topics.

11. The non-transitory computer-readable medium of claim 10, further comprising instructions that, when executed by the at least one processor, cause the computer device to generate, utilizing a topic-verbatim correlation model, correlations between verbatim-derived topics of the dataset of verbatim-derived topics and individual verbatims of the one or more verbatims.

12. The non-transitory computer-readable medium of claim 11, further comprising instructions that, when executed by the at least one processor, cause the computer device to assign at least one context-driven topic of the one or more context-driven topics to a respective verbatim of the one or more verbatims based on the mapping of verbatim-derived topics to the one or more context-driven topics and the correlations between the verbatim-derived topics of the dataset of verbatim-derived topics and the individual verbatims of the one or more verbatims.

13. The non-transitory computer-readable medium of claim 12, further comprising instructions that, when executed by the at least one processor, cause the computer device to:
receive at least one additional context-driven topic; and
update, utilizing the topic disambiguation model, the mapping of the verbatim-derived topics from the dataset of verbatim-derived topics to the one or more context-driven topics and the at least one additional context-driven topic.

14. The non-transitory computer-readable medium of claim 10, wherein the one or more context-driven topics are determined based on contextual information associated with one or more of a particular industry, a particular organization, a user-provided set of verbatims, or user-provided topics of interest.

15. The non-transitory computer-readable medium of claim 10, further comprising instructions that, when executed by the at least one processor, cause the computer device to:
provide, to the topic disambiguation model, additional verbatim-derived topics determined from one or more additional verbatims by the topic extraction model; and
update, utilizing the topic disambiguation model, the mapping of the verbatim-derived topics from the dataset of verbatim-derived topics to the one or more context-driven topics with an additional mapping of the additional verbatim-derived topics to the one or more context-driven topics.

16. A system comprising:
at least one processor; and
at least one non-transitory computer-readable medium storing instructions that, when executed by the at least one processor, cause the system to:
provide, to a topic disambiguation model, a dataset of verbatim-derived topics determined from one or more verbatims by a topic extraction model, the one or more verbatims comprising natural language user input text;
provide, to the topic disambiguation model, one or more context-driven topics identified independent of the one or more verbatims of the dataset of verbatim-derived topics; and
generate, utilizing the topic disambiguation model, a mapping of verbatim-derived topics from the dataset of verbatim-derived topics to the one or more context-driven topics.

17. The system of claim 16, further comprising instructions that, when executed by the at least one processor, cause the system to:
identify the one or more context-driven topics based on one or more of user-selected topics or topics generated based on user-provided contextual information; and
determine, in response to receiving the one or more verbatims, the dataset of verbatim-derived topics utilizing a topic extraction model.

18. The system of claim 17, further comprising instructions that, when executed by the at least one processor, cause the system to generate, based on the mapping of the verbatim-derived topics from the dataset of verbatim-derived topics to the one or more context-driven topics, a topic hierarchy comprising the one or more context-driven topics and the verbatim-derived topics of the dataset of verbatim-derived topics.

19. The system of claim 18, further comprising instructions that, when executed by the at least one processor, cause the system to generate, utilizing a topic-verbatim correlation model, correlations between the verbatim-derived topics of the dataset of verbatim-derived topics and individual verbatims of the one or more verbatims.

20. The system of claim 19, further comprising instructions that, when executed by the at least one processor, cause the system to assign the one or more verbatims to respective topics within the topic hierarchy based on the correlations between the verbatim-derived topics of the dataset of verbatim-derived topics and the individual verbatims of the one or more verbatims.
